(19) United States
(12) Patent Application Publication
(10) Pub. No.: US 2006/0239448 A1
(43) Pub. Date: Oct. 26, 2006

(54) In-field upgrade management of data capture systems

(76) Inventors: Robert James Pang, Williston Park, NY (US); Thomas D. Bianculli, Manorville, NY (US); Robert May, Sayville, NY (US); Christopher James Fjellstad, Smithtown, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/095,176

(22) Filed: Mar. 31, 2005

(51) Int. Cl. H04M 9/00

(52) U.S. Cl. 379/910

(57) ABSTRACT

Update data is uploaded in the field to data capture systems, such as electro-optical readers, RFID readers, and imagers, either before, after, or during data capture.

### BACKGROUND OF THE INVENTION

1. Field of the Invention

The present invention generally relates to in-field management of data capture systems, such as electro-optical readers, preferably laser scanners for reading indicia, such as bar code symbols, as well as imagers for capturing an image of such indicia, as well as radio frequency identification (RFID) devices for identifying targets and, more particularly, to communications between a data capture system and a transaction terminal for updating and upgrading the data capture system, particularly during data capture.

2. Description of the Related Art

Various electro-optical systems or readers have been developed for reading indicia such as bar code symbols appearing on a label or on a surface of an article. The bar code symbol itself is a coded pattern of graphic indicia comprised of a series of bars of various widths spaced apart from one another to bound spaces of various widths, the bars and spaces having different light reflecting characteristics. The readers function by electro-optically transforming the pattern of the graphic indicia into a time-varying electrical signal, which is digitized and decoded into data relating to the symbol being read.

Typically, a laser beam from a laser is directed along a light path toward a target that includes the bar code symbol on a target surface. A moving-beam scanner operates by repetitively sweeping the laser beam in a scan line or a series of scan lines across the symbol by means of motion of a scanning component, such as the laser itself or a scan mirror disposed in the path of the laser beam. Optics focus the laser beam into a beam spot on the target surface, and the motion of the scanning component sweeps the beam spot across the symbol to trace a scan line across the symbol. Motion of the scanning component is typically effected by an electrical drive motor.

The readers also include a sensor or photodetector which detects light along the scan line that is reflected or scattered from the symbol. The photodetector or sensor is positioned such that it has a field of view which ensures the capture of the reflected or scattered light, and converts the latter into an electrical analog signal.

In retroreflective light collection, a single optical component, e.g., a reciprocally oscillatory mirror, such as described in U.S. Pat. No. 4,816,661 or U.S. Pat. No. 4,409,470, both herein incorporated by reference, sweeps the beam across the target surface and directs the collected light to the sensor. In non-retroreflective light collection, the reflected laser light is not collected by the same optical component used for scanning. Instead, the sensor is independent of the scanning beam, and has a large field of view so that the reflected laser light traces across the sensor.

Electronic control circuitry and software decode the electrical analog signal from the sensor into a digital representation of the data represented by the symbol that has been scanned. For example, the analog electrical signal generated by the photodetector may be converted by a digitizer into a pulse width modulated digitized signal, with the widths corresponding to the physical widths of the bars and spaces. Alternatively, the analog electrical signal may be processed directly by a software decoder. See, for example, U.S. Pat. No. 5,504,318.

The decoding process usually works by applying the digitized signal to a microprocessor running a software algorithm, which attempts to decode the signal. If a symbol is decoded successfully and completely, the decoding terminates, and an indicator of a successful read (such as a green light and/or audible beep) is provided to a user. Otherwise, the microprocessor receives the next scan, and performs another decoding into a binary representation of the data encoded in the symbol, and to the alphanumeric characters so represented. Once a successful read is obtained, the binary data is communicated to a host computer for further processing, for example, information retrieval from a look-up table.

Both one- and two-dimensional symbols can be read by employing moving-beam scanners, as well as solid-state imagers. For example, an image sensor device may be employed which has a one- or two-dimensional array of cells or photosensors which correspond to image elements or pixels in a field of view of the device. Such an image sensor device may include a one- or two-dimensional charge coupled device (CCD) or a complementary metal oxide semiconductor (CMOS) device and associated circuits for producing electronic signals corresponding to a one- or two-dimensional array of pixel information for a field of view.

It is therefore known to use a solid-state device for capturing a monochrome image of a symbol as, for example, disclosed in U.S. Pat. No. 5,703,349. It is also known to use a solid-state device with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

It is also known to use radio waves to automatically identify objects, people, or like targets. An RFID tag or transponder identifies a target. An RFID reader interrogates the tag and converts radio waves reflected back from the tag into digital data.

As satisfactory as such moving-beam scanners, imagers and RFID devices are in capturing data, such data capture systems are not easily updated in the field. Typically, a portable data capture system is connected, and movable relative, to a transaction terminal operative for processing the transaction data captured by the system. It is up to a human user to disconnect the system and initiate the process of connecting the system to a dedicated configuration computer operative for upgrading the system. This can lead to costly disruptions due to the system being out of service. In some applications, there is a multitude of systems that are operatively connected to a single transaction terminal. Disconnecting and upgrading each system, in turn, is a laborious procedure. Frequently, many systems are simply not upgraded due to the great effort involved.

### SUMMARY OF THE INVENTION

### OBJECTS OF THE INVENTION

Accordingly, it is a general object of this invention to add in-field management upgrade functionality to data capture systems, especially portable systems.

It is an additional object of the present invention to upgrade a data capture system while the latter is capturing data.

It is another object of the invention to upgrade a data capture system while the latter is not capturing data.

It is a further object of the present invention to provide management communication between a data capture system and a transaction terminal.

### FEATURES OF THE INVENTION

In keeping with the above objects and others which will become apparent hereinafter, one feature of the present invention resides, briefly stated, in an arrangement for, and a method of, in-field managing a data capture system such as an electro-optical reader for reading indicia, such as bar code symbols, or an imager for imaging a target, or an RFID reader for interrogating a target with radio waves, by operatively connecting a transaction terminal, for example, a point of sale workstation, to the data capture system via a wireless or wired link, and by uploading update data from the terminal to the data capture system while the latter remains operatively connected to the terminal. In other words, the data capture system is not disconnected from the terminal, but remains operatively connected thereto by either the wired or wireless link. The data capture system is upgraded directly from the terminal and not, as in the prior art, by being disconnected from the terminal (i.e., taken off-line), then connected to a different dedicated configuration computer remote from the terminal for the upgrade, and then reconnected to the terminal.

The upgrade is performed, in accordance with this invention, preferably during data capture, but it can also be performed while data is not being captured by the data capture system. There is a memory onboard the data capture system. The memory can be contained within a microprocessor used for controlling operation of the data capture system and for at least partially processing transaction data captured by the system. The transaction data includes information, typically indicative of an indicium being electro-optically read, or a target being imaged or interrogated. The memory can also be contained within a separate memory chip connected to the microprocessor, or the memory can be shared between the separate chip and the microprocessor.

The available total memory dictates whether the upgrade is performed during, after or before the transaction data is captured. Typically, a major memory storage portion of the total memory is employed in storing software for controlling system operation and for processing the transaction data, i.e., the normal functioning of the data capture system. A minor memory storage portion of the total memory is used to store an update program. There typically is no more available memory to store the update data.

Hence, in this embodiment, when the update program is executed, in response to an update command from the terminal, the update program overwrites that major memory storage portion of the memory to accept the update data software. It will, of course, be appreciated that no data capture can occur during this overwrite procedure. However, this downtime is disadvantageous. Also, in the event of an interruption in power or communications with the data capture system during the overwrite procedure, the update fails, and an end user is responsible for repairing the failed update, for example, by connecting the system to a dedicated configuration computer as taught by the prior art.

More useful is providing additional memory to store the update data software. The update program, as before, is executed, but, this time, there is no overwriting of the major memory storage portion of the memory used for storing the software for controlling system operation and for processing the transaction data. The update data software is stored in the additionally provided memory storage area.

Hence, in this embodiment, the data capture system remains fully functional even while the system is being upgraded. There is no downtime. Any power or communications interruption is not fatal since the upgrade can be repeated after verification that the full upgrade has not been uploaded to the system.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an electro-optical reader in accordance with the prior art;

FIG. 2 is a circuit schematic depicting an in-field management arrangement in accordance with the present invention for upgrading data capture systems, one of which advantageously being the reader of FIG. 1;

FIG. 3 is a diagrammatic view of a microprocessor arrangement with limited memory in accordance with one embodiment of the present invention; and

FIG. 4 is a diagrammatic view of a microprocessor arrangement with enhanced memory in accordance with another embodiment of the present invention.

### DETAILED DESCRIPTION OF THE PREFERRED EMBODIMENTS

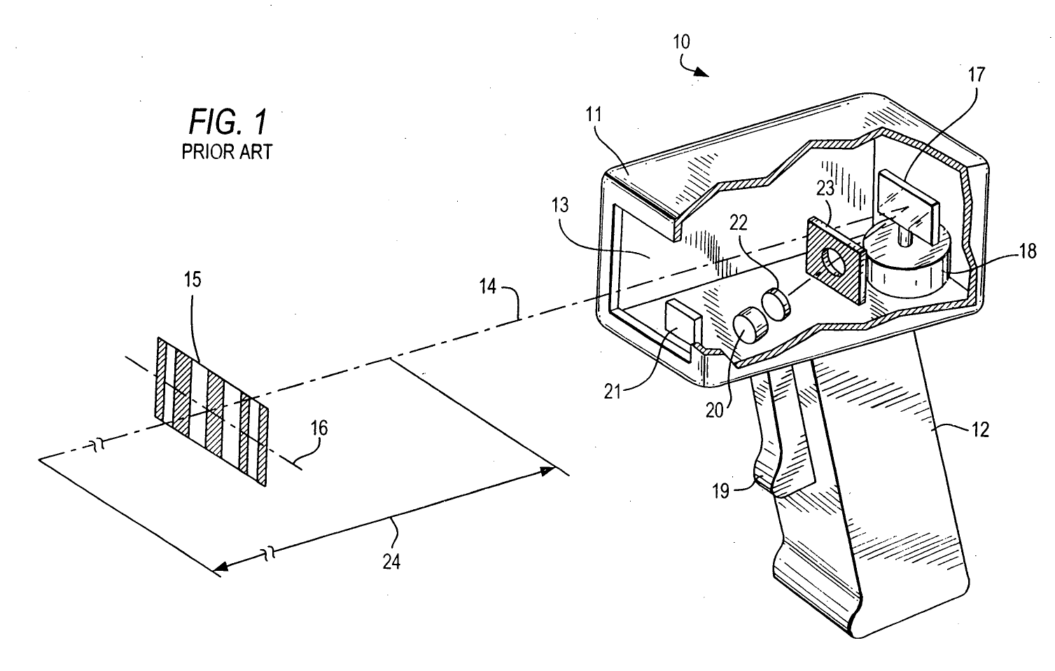

As used herein, the term “symbol” broadly encompasses not only symbol patterns composed of alternating bars and spaces of various widths as commonly referred to as bar code symbols, but also other one- or two-dimensional graphic patterns, as well as alphanumeric characters. In general, the term “symbol” may apply to any type of pattern or indicia which may be recognized or identified either by scanning a light beam and detecting reflected or scattered light as a representation of variations in light reflectivity at various points of the pattern or indicia. FIG. 1 shows an indicia 15 as one example of a “symbol” to be read.

FIG. 1 depicts a handheld laser scanner device 10 for reading symbols. The laser scanner device 10 includes a housing having a barrel portion 11 and a handle 12. The barrel portion 11 of the housing includes an exit port or window 13 through which an outgoing laser light beam 14 passes to impinge on, and scan across, the bar code symbol 15 located at some distance from the housing.

The laser beam 14 moves across the symbol 15 to create a scan pattern. Typically, the scanning pattern is one-dimensional or linear, as shown by line 16. This linear scanning movement of the laser beam 14 is generated by an oscillating scan mirror 17 driven by an oscillating motor 18. If desired, means may be provided to scan the beam 14 through a two-dimensional scanning pattern, to permit reading of two-dimensional optically encoded symbols. A manually-actuated trigger 19 or similar means permit an operator to initiate the scanning operation when the operator holds and aims the device 10 at the symbol 15.

The scanner device 10 includes a laser source 20 mounted within the housing. The laser source 20 generates the laser beam 14. A photodetector 21 is positioned within the housing to collect at least a portion of the light reflected and scattered from the bar code symbol 15. The photodetector 21, as shown, faces toward the window 13 and has a static, wide field of view characteristic of the non-retro-reflective readers described above. Alternatively, in a retro-reflective reader, a convex portion of the scan mirror 17 may focus collected light on the photodetector 21, in which case the photodetector faces toward the scan mirror. As the beam 14 sweeps the symbol 15, the photodetector 21 detects the light reflected and scattered from the symbol 15 and creates an analog electrical signal proportional to the intensity of the collected light.

A digitizer typically converts the analog signal into a pulse width modulated digital signal, with the pulse widths and/or spacings corresponding to the physical widths of the bars and spaces of the scanned symbol 15. A decoder, typically comprising a programmed microprocessor 56 (see FIGS. 3-4) with associated random access memory (RAM) and read only memory (ROM), decodes the pulse width modulated digital signal according to the specific symbology to derive a binary representation of the data encoded in the symbol, and the alphanumeric characters represented by the symbol.

The laser source 20 directs the laser beam through an optical assembly comprising a focusing lens 22 and an aperture stop 23, to modify and direct the laser beam onto the scan mirror 17. The mirror 17, mounted on a vertical shaft and oscillated by the motor drive 18 about a vertical axis, reflects the beam and directs it through the exit port 13 to the symbol 15.

To operate the scanner device 10, the operator depresses trigger 19 which activates the laser source 20 and the motor 18. The laser source 20 generates the laser beam which passes through the element 22 and aperture 23 combination. The element 22 and aperture 23 modify the beam to create an intense beam spot of a given size which extends continuously and does not vary substantially over a range 24 of working distances. The element and aperture combination directs the beam onto the rotary mirror 17, which directs the modified laser beam outwardly from the scanner housing 11 and toward the bar code symbol 15 in a sweeping pattern, i.e., along scan line 16. The bar code symbol 15, placed at any point within the working distance 24 and substantially normal to the laser beam 14, reflects and scatters a portion of the laser light. The photodetector 21, shown mounted in the scanner housing 11 in a non-retro-reflective position, detects the reflected and scattered light and converts the received light into an analog electrical signal. The photodetector could also be mounted in a retro-reflective position facing the scan mirror 17. The system circuitry then converts the analog signal to a pulse width modulated digital signal which a microprocessor-based decoder decodes according to the characteristics of the bar code symbology rules.

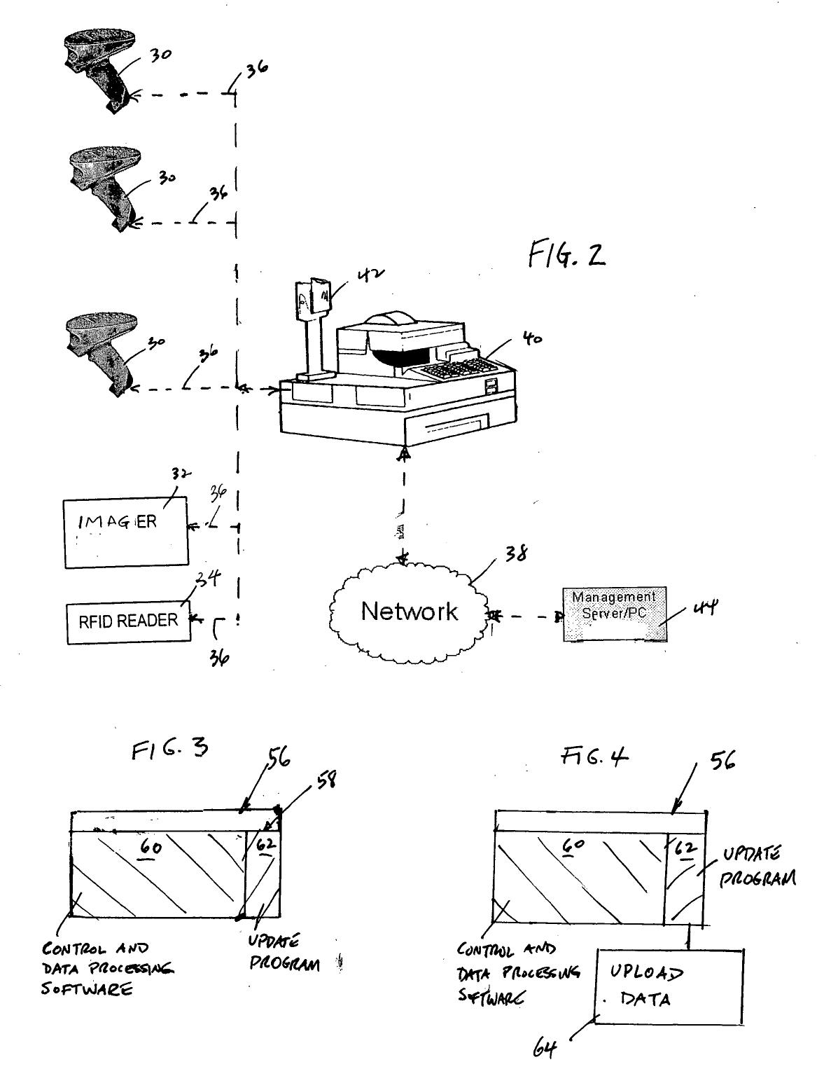

As described so far, the handheld scanner device 10 is a data capture system for capturing transaction data indicative of the symbol 15. FIG. 2 depicts an architecture for in-field managing of at least one data capture system, and preferably a multitude of such data capture systems, such as handheld laser scanner devices 30, essentially identical to device 10, imaging reader 32 for capturing an image of the symbol or a target prior to processing the image into the transaction data, and an RFID reader 34 for interrogating an RFID tag or transponder to obtain the transaction data. The illustrated number and type of data capture system in FIG. 2 is merely exemplary, since more or less than the illustrated systems can, and often is, employed in a real-world application. Other data capture systems contemplated by this invention include card readers, such as magnetic stripe readers and smart card readers, and devices having a screen for capturing a signature, a fingerprint, or a human touch.

Each of these systems has a hard-wired, or preferably a wireless, connection 36 to one or more access points or nodes of a network 38. One of the nodes is depicted as a transaction terminal 40, preferably constituted as a cash register in a supermarket environment. However, it will be understood that the terminal is not to be restricted to a cash register and that any host computer, such as a laptop computer or a desktop computer, will do. Also, the terminal need not be stationary and can be mobile. The term “terminal” is to be interpreted in its broadest sense as any device having intelligence. The terminal 40 may have a cradle 42 for supporting the system. Each system preferably has a wireless transceiver for communication over a wireless interface, such as wide area network (WAN), local area network (LAN), or personal area network (PAN), such as Bluetooth (Trademark). More transaction terminals are often configured in the network 38. Each data capture system is preferably handheld, portable and movable relative to the terminal to which the system is operatively connected by a wired or wireless connection.

A management server 44, typically a computer, is operatively connected over the network 38 to one or more terminals 40 which, in turn, is operatively connected to one or more data capture systems. All communication is bi-directional. Each transaction terminal 40 is operative for processing the transaction data captured by a respective system. This typically involves retrieving information, for example, prices, from a look-up table on the network 38, or retrieving inventory information.

In accordance with this invention, update data is uploaded from the terminal to one, some, or all the data capture systems. From time to time, the firmware on each system is updated for enhanced system operation. Typically, the management server 44 initiates the upload over the network 38 to the transaction terminal which, in turn, communicates the update data to the system. If the terminal permits, the upload can be initiated from the terminal itself.

FIG. 3 depicts the aforementioned microprocessor 56 for controlling system operation and processing the transaction data. As previously mentioned, the microprocessor 56 has associated memory 58, typically about 2Mbits flash memory and about 16 Kbytes RAM. Virtually all the available memory, i.e., a major portion 60 of the memory 58, is used to store the software for controlling system operation and transaction data processing. There is not enough additional memory storage available to simultaneously store the update data to be uploaded.

In accordance with one embodiment of this invention, an update program of limited size is stored in a minor portion 62 of the memory storage area of the microprocessor memory. In response to an upload command, the update program self-executes and uploads the update data to the very same microprocessor memory portion 60 previously used by the software for controlling system operation and transaction data processing. In short, this memory storage area 60 is overwritten by the update data. During this upload procedure, the system is not operational to capture transaction data. The system is down and off-line. In the event of power or communications interruption during this upload procedure, the upload fails, and it is up to the end user to employ error recovery techniques. For example, the user may have to connect the system to a dedicated computer to redo the upload, or the user may return the system to the manufacturer. Both these options are undesirable not only from a downtime point of view, but also from the standpoint of customer satisfaction.

In accordance with another, and the preferred, embodiment of this invention, the microprocessor memory is increased, for example, by serially connecting an additional memory chip 64, preferably an EEPROM having another 2 Mbits of memory. This time, rather than having the update program overwrite the memory portion 60, the update programs loads an image of the update data into the additional memory of the memory chip 64. During this upload procedure, the system remains operational to capture transaction data, and the update program essentially operates in the background. In the event of power or communications interruption during this upload procedure, the upload program can be reexecuted and verified before it is activated. There is no system downtime, thereby enhancing user satisfaction with such automatic upgrading.

In connection with both embodiments, the update program is also operative for verifying that the update data is intended for a particular data capture system to be upgraded, and also for verifying that the upload was complete. To aid in such verification, each upload is provided by the management server 44 with a unique signature or identification.

In the preferred embodiment, the additional memory should be non-volatile. If compressed data is used, then the additional memory need not be as large as if uncompressed data were used. If the additional cost of the extra chip 64 is to be avoided, then a microprocessor with increased memory may be used.

It will be understood that each of the elements described above, or two or more together, also may find a useful application in other types of constructions differing from the types described above.

While the invention has been illustrated and described as embodied in in-field upgrade management of data capture systems, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An arrangement for in-field managing at least one data capture system operative for capturing transaction data, comprising:
a) a transaction terminal operatively connected to the at least one data capture system that is movable relative to the terminal, the terminal being operative for processing the transaction data; and
b) means for uploading update data from the terminal to the at least one data capture system while the latter remains operatively connected to the terminal.

2. The arrangement of claim 1, wherein the transaction terminal is a workstation, and wherein the at least one data capture system is an electro-optical reader for reading indicia.

3. The arrangement of claim 2, wherein the reader is operatively connected to the transaction terminal by one of a wired and a wireless link.

4. The arrangement of claim 2, wherein the reader is one of a laser scanner for scanning the indicia with a laser beam, and an imager for capturing an image of the indicia.

5. The arrangement of claim 1, and a host computer operatively connected to the transaction terminal, and wherein the uploading means is operative for uploading the update data to the terminal.

6. The arrangement of claim 1, wherein the at least one data capture system is a handheld device movable relative to the terminal.

7. The arrangement of claim 1, wherein the at least one data capture system is a radio frequency identification (RFID) device.

8. The arrangement of claim 1, wherein the uploading means is operative to upload the update data while the at least one data capture system is capturing the transaction data.

9. The arrangement of claim 8, and a memory onboard the at least one data capture system, the memory having a transaction data processing first storage area in which the transaction data is processed, and an update data processing second storage area in which the update data is processed, the first and second areas being distinct from each other.

10. The arrangement of claim 9, wherein the first and second areas are contained in a single memory chip.

11. The arrangement of claim 9, wherein the first and second areas are contained in separate memory chips.

12. The arrangement of claim 1, wherein the uploading means is operative to upload the update data when the at least one data capture system is not capturing the transaction data.

13. The arrangement of claim 12, and a memory onboard the at least one data capture system, the memory having a single storage area in which both the transaction data and the update data are processed, but not simultaneously.

14. A method of in-field managing at least one data capture system operative for capturing transaction data, comprising the steps of:
a) operatively connecting a transaction terminal to the at least one data capture system that is movable relative to the terminal, the transaction terminal being operative for processing the transaction data; and
b) uploading update data from the terminal to the at least one data capture system while the latter remains operatively connected to the terminal.

15. The method of claim 14, wherein the uploading of the update data is performed while the at least one data capture system is capturing the transaction data.

16. The method of claim 14, wherein the uploading of the update data is performed while the at least one data capture system is not capturing the transaction data.

17. An in-field manageable data capture system, comprising:
a) means supported by the data capture system, for operatively connecting the latter to a transaction terminal operative for processing transaction data captured by the data capture system; and
b) a memory supported by the data capture system, for storing update data uploaded from the terminal while the data capture system remains operatively connected to the terminal.

18. The system of claim 17, wherein the connecting means is one of a wired and a wireless link.

19. The system of claim 17, wherein the memory has a transaction data processing first storage area in which the transaction data is processed, and an update data processing second storage area in which the update data is processed.

20. The system of claim 19, wherein the first and second areas are distinct areas to enable the upload of the update data while the system is capturing the transaction data.

21. The system of claim 19, wherein the first and second areas are the same to enable the upload of the update data while the system is not capturing the transaction data.

22. An arrangement for in-field managing at least one data capture system operative for capturing transaction data, comprising:
a) a transaction terminal operatively connected to the at least one data capture system and operative for processing the transaction data; and
b) means for uploading update data from the terminal to the at least one data capture system without rendering the at least one data capture system inoperative to capture the transaction data.

23. The arrangement of claim 22, wherein the uploading means includes a memory associated with the at least one data capture system, the memory including a transaction data processing first storage area in which the transaction data is processed, and an update data processing second storage area in which the update data is processed, the first and second areas being distinct from each other.

24. A method of in-field managing at least one data capture system operative for capturing transaction data, comprising the steps of:
a) operatively connecting a transaction terminal to the at least one data capture system for processing the transaction data; and
b) uploading update data from the terminal to the at least one data capture system without rendering the at least one data capture system inoperative to capture the transaction data.

25. The method of claim 24, wherein the uploading step includes associating a memory with the at least one data capture system, the memory including a transaction data processing first storage area in which the transaction data is processed, and an update data processing second storage area in which the update data is processed, the first and second areas being distinct from each other.
